(19) United States
(12) Patent Application Publication
(10) Pub. No.: US 2026/0292535 A1
(43) Pub. Date: Sep. 24, 2026

(54) Data Collection and Test System for Delay-Critical Services

(71) Applicant: Telefonaktiebolaget LM Ericsson (publ), Stockholm (SE)

(72) Inventors: Attila Báder, Paty (HU); Gergely Dobreff, Budapest (HU); Márk Péter Szalay, Budapest (HU); Márton Molnár, Ózd (HU); Bence Ladóczki, Budapest (HU); Alija Pasic, Pilisvörösvár (HU); Zoltán Móczár, Budapest (HU)

(21) Appl. No.: 18/996,103

(22) PCT Filed: Jul. 28, 2022
(86) PCT No.: PCT/IB2022/057012

§ 371 Date: Jan. 17, 2025

(51) Int. Cl. H04W 24/02; G06N 20/00; H04L 41/16; H04L 41/5009; H04L 41/5067

(52) U.S. Cl. CPC H04W 24/02; G06N 20/00; H04L 41/16; H04L 41/5009; H04L 41/5067

(57) ABSTRACT

A mobile system (120) trains a Quality of Experience, QoE, model. To do so, the mobile device captures packets of an Ultra-Reliable Low-Latency Communication, URLLC, service transported over a wireless connection. The mobile device introduces a disturbance impacting the URLLC service. The mobile system (120) monitors service quality of the URLLC service while the URLLC service is impacted by the disturbance and while the URLLC service is not impacted by the disturbance. The mobile system (120) updates the QoE model (118) based on the monitored service quality.

### TECHNICAL FIELD

The present disclosure is generally related to the field of wireless communication networks and, more particularly, to collecting and analyzing data collected within a wireless communication network to assess network performance.

### BACKGROUND

It has been predicted that the number of 5G subscribers will reach 4.4 billion globally by the end of 2027, accounting for almost half of all mobile subscriptions and contributing to more than 60 percent of the world's total mobile data traffic. Over the last decade, both the research community and industry players have devoted significant efforts to investigate the traffic characteristics and user experience of legacy Mobile Broadband (MBB) services, such as web browsing and video streaming for which Long Term Evolution (LTE) networks were optimized. Current trends suggest that 5G will become the dominant radio access technology in the upcoming years and shape the future of mobile communications by enabling a wide range of new services and use cases.

5G New Radio (NR), a novel air interface developed by the Third Generation Partnership Project (3GPP), is designed to satisfy the demands of emerging Ultra-Reliable Low-Latency Communication (URLLC) services. Such demands include 360-degree video streaming, cloud gaming, immersive AR/VR applications, remote control and industrial automation. Unlike MBB traffic which typically needs high-bandwidth connections with only best-effort latency, URLLC services have stringent requirements on latency and reliability due to their real-time nature. Adaptive video streaming, which drives mobile traffic growth in terms of data volume, is tolerant to network Quality of Service (QoS) changes as client-side buffers are able to mask delay fluctuations originating from either the underlying transport mechanisms or the application itself. In contrast, for low-latency communication, data delivery generally must be ensured within specific latency bounds with at least 99.999 percent probability, depending on the given use case. For example, while cloud gaming platforms can often deliver a lag-free gaming experience with up to 100 ms of round-trip time in some cases, industrial robots cannot operate reliably unless latency is kept under 5 ms.

To measure service quality, MNOs have traditionally deployed passive probes in their networks that are capable of collecting packet-level information needed to calculate meaningful metrics for various types of network traffic. Earlier approaches to predicting Quality of Experience (QoE) have mainly consisted of simplified analytical models built on human expert knowledge and observations.

Per-session advanced analytics systems, such as Ericsson Expert Analytics (EEA), are based on collecting and correlating elementary network events from different network domains, such as core, radio and transport networks. They calculate user and session level end-to-end (e2e) service quality metrics (e.g., Service Key Performance Indicators (S-KPIs) or QoE metrics) as well as Radio and network resource KPIs (R-KPIs), characterizing radio environment or network operation at the user and session level. These types of solutions are generally suitable for session-based troubleshooting and analysis of network issues.

Event-based analytics systems are also used in Service Operation Centers (SOC) for monitoring the quality of the wide variety of services used in the network level, as well as for monitoring the customer experience on individual per subscriber level. These tools are widely used in customer care and other business scenarios.

Event-based analytics typically requires real-time collection and correlation of characteristic node and protocol events from different radio and core nodes, probing signaling interfaces (IFs) and sampling of user plane traffic as well. Beside the data collection and correlation functions, the system typically requires an advanced database, rule engine, and big data analytics platform.

Because of the introduction of 5G mobile networks, it is expected that mobile networks will serve a large variety of new service types (e.g., delay-critical URLLC service types). In addition, it is expected that these networks will serve a much higher number of devices or user equipments (UEs) than in previous network technologies.

### SUMMARY

Embodiments of the present disclosure are generally directed to the collection of training data used for machine learning models in order to predict the service quality of new delay critical service types, such as those transported over UDP/RTP, UDP/SRTP or UDP/QUIC protocols for example. Particular embodiments are suitable for testing new radio bearers and settings used for these new service types in 5G or later mobile networks as well as for deriving relations between different radio issues, transport characteristics, and end user service quality.

Particular embodiments include a method of training a QoE model implemented by a mobile system. The method comprises capturing packets of a URLLC service transported over a wireless connection and introducing a disturbance impacting the URLLC service. The method further comprises monitoring service quality of the URLLC service while the URLLC service is impacted by the disturbance and while the URLLC service is not impacted by the disturbance. The method further comprises updating the QoE model based on the monitored service quality.

In some embodiments, the method further comprises correlating each of the captured packets with either when the URLLC service was impacted or when the URLLC service was not impacted by the disturbance. Updating the QoE model is further based on the correlated packets.

In some embodiments, monitoring the service quality of the URLLC service comprises collecting radio environment measurements of an uplink and/or downlink supporting the URLLC service. Further, updating the QoE model based on the service quality comprises using the collected radio environment measurements as training data to train the QoE model. In some such embodiments, the radio environment measurements comprise signal quality measurements of the downlink and transmission power of the uplink.

In some embodiments, monitoring the service quality of the URLLC service comprises collecting radio configuration parameters of one or more radio devices supporting the URLLC service. Further, updating the QoE model based on the service quality comprises using the collected radio configuration parameters as training data to train the QoE model. In some such embodiments, the radio configuration parameters comprise timing advance and/or a used frequency.

In some embodiments, monitoring the service quality of the URLLC service comprises collecting QoE configuration parameters associated with the URLLC service. Further, updating the QoE model based on the service quality comprises using the collected QoE configuration parameters as training data to train the QoE model. In some such embodiments, the QoE configuration parameters comprise packet loss, jitter, and/or round trip time requirements for providing QoE with respect to the URLLC service.

In some embodiments, monitoring the service quality of the URLLC service comprises collecting transport measurements of the URLLC service. Further, updating the QoE model based on the service quality comprises using the collected transport measurements as training data to train the QoE model. In some such embodiments, the transport measurements comprise bitrate and/or throughput measurements of the URLLC service.

In some embodiments, monitoring the service quality of the URLLC service comprises generating periodic sample data of the service quality, the periodic sample data having a resolution of not more than one second. Further, updating the QoE model based on the service quality comprises using the periodic sample data as training data to train the QoE model.

In some embodiments, capturing packets of the URLLC service comprises capturing Real-time Transport Protocol (RTP), Secure RTP, and/or Quick UDP Internet Connections packets.

In some embodiments, the packets of the URLLC service comprise an encrypted portion and an unencrypted portion. Further, monitoring the service quality comprises deriving performance data of the URLLC service based on the unencrypted portion and without decrypting the encrypted portion. Further, updating the QoE model based on the service quality comprises using the performance data as training data to train the QoE model.

In some embodiments, monitoring the service quality of the URLLC service comprises generating a round trip data sample for each of a plurality of spin bit inversions detected within the captured packets. Further, updating the QoE model based on the service quality comprises using the round trip data samples as training data to train the QoS model.

In some embodiments, the method further comprises performing a handover procedure responsive to the disturbance, wherein monitoring the service quality comprises monitoring the service quality before and after the handover procedure.

In some embodiments, introducing the disturbance comprises introducing a transport data disruption. In some such embodiments, introducing the transport data disruption comprises introducing packet loss, jitter, delay, packet reordering, congestion, and/or packet fragmentation.

In some embodiments, introducing the disturbance comprises introducing a disruption to radio conditions of the wireless connection.

Other embodiments include a mobile system. The mobile system comprises processing circuitry and memory circuitry. The memory circuitry stores instructions executable by the processing circuitry whereby the mobile system is configured to capture packets of a URLLC service transported over a wireless connection. The mobile system is further configured to introduce a disturbance impacting the URLLC service and monitor service quality of the URLLC service while the URLLC service is impacted by the disturbance and while the URLLC service is not impacted by the disturbance. The mobile system is further configured to update the QoE model based on the monitored service quality.

In some embodiments, the mobile system is further configured to perform any of the embodiments of the method described above.

Yet other embodiments include a computer program comprising instructions that, when executed on processing circuitry of a mobile system, cause the mobile system to carry out any of the embodiments of the method described above.

Still other embodiments include a carrier containing said computer program. The carrier is one of an electronic signal, optical signal, radio signal, or computer readable storage medium.

### BRIEF DESCRIPTION OF THE DRAWINGS

Aspects of the present disclosure are illustrated by way of example and are not limited by the accompanying figures with like references indicating like elements. In general, the use of a reference numeral should be regarded as referring to the depicted subject matter according to one or more embodiments, whereas discussion of a specific instance of an illustrated element will append a letter designation thereto (e.g., discussion of a computing device 110, generally, as opposed to discussion of particular instances of computing devices 110a, 110b).

FIG. 1 is a block diagram that schematically illustrates the architecture of a wireless communication network according to one or more embodiments of the present disclosure.

FIG. 2 is a flow diagram illustrating an example method performed by the mobile system 120 according to one or more embodiments of the present disclosure.

FIG. 3 is a timeline that schematically illustrates an example of a measurement descriptor according to one or more embodiments of the present disclosure.

FIG. 4 illustrates timestamped and parameterized data structures used by respective monitors according to one or more embodiments of the present disclosure.

FIG. 5 illustrates an example combined output data structure according to one or more embodiments of the present disclosure.

FIG. 6 is a block diagram that schematically illustrates example uplink and downlink processing according to one or more embodiments of the present disclosure.

FIG. 7-13 are graphs illustrating example measurements according to one or more embodiments of the present disclosure.

FIG. 14 is a flow diagram illustrating an example method implemented by a mobile system according to one or more embodiments of the present disclosure.

FIG. 15 is a schematic block diagram illustrating an example mobile system according to one or more embodiments of the present disclosure.

### DETAILED DESCRIPTION

Due to the strict constraints of delay-critical services, it is becoming increasingly important for Mobile Network Operators (MNOs) to detect quality impairments and react swiftly to performance degradations, e.g., through automated closed-loop actions. However, a variety of factors presently hinder such efforts. For example, increasingly pervasive end-to-end encryption is making development of reliable traffic monitoring solutions increasingly difficult. As a result, customers may receive an increasingly suboptimal user experience and become increasingly dissatisfied.

A significant technological driver behind encryption is the introduction of new protocols that put more focus on security and privacy aspects by design than ever before. Specifically, the latest version of Transport Layer Security (TLS) and its variant tailored for User Datagram Protocol (UDP)-based data transmission (i.e., Datagram Transport Layer Security (DTLS)), provide enhanced security over their predecessors by means of forward secrecy and encrypted handshakes. Large-scale deployment of the recently standardized Quick UDP Internet Connections (QUIC) protocol has already started, which also represents a huge step towards Internet-wide encryption as QUIC is designed to encrypt all data at the transport layer. QUIC ensures reliable transport similar to Transmission Control Protocol (TCP) coupled with several additional features and improvements but significantly limits the observability of protocol messages, leaving scant options for performance monitoring and troubleshooting.

The trend of prioritizing security and privacy aspects has led to a significant decrease in data visibility and accessibility. Most of the network traffic is already encrypted by TLS and QUIC protocols which makes it challenging to predict service quality. In addition to packet payloads, some parts of protocol handshake messages and header fields are also hidden from passive monitoring devices (e.g., network probes). Existing QoE assessment methods are tailored for legacy MBB applications, whereas the quality provided by delay-critical services is poorly understood. Accordingly, a new framework is needed to identify and extract relevant information from encrypted data streams that helps to characterize the QoE of these emerging 5G services.

The typical way of building QoE models is to collect and utilize transport-level data obtained from monitoring nodes. Although end-to-end network QoS parameters (latency, packet loss, etc.) are indeed important indicators of possible performance degradations, signal quality and mobility events can also highly affect the user experience in mobile networks. For example, inter-frequency handovers or switching between different radio access technologies may interrupt ongoing data transmissions that can lead to suboptimal QoE, especially in the case of latency-sensitive applications. To improve prediction accuracy, besides analyzing core network data it is crucial to explore the impact of radio conditions on transport characteristics and service quality in several real-world scenarios.

Obtaining e2e transport metrics (latency, packet loss, jitter, etc.) is either difficult or impossible to accomplish solely by network probing because, in many cases, an e2e transport report (e.g., in case of UDP or Real-Time TCP (RTCP)) is missing. Alternatively, e2e metrics should perhaps be derived from multiple path segments and the resolution of data are different or data for certain segments are not available.

While certain methods of assessing the QoE of traditional MBB applications are already available and can be adequate for particular needs, the traffic characteristics of URLLC services and their complex relationship with user-perceived quality are barely understood. In order to develop accurate performance metrics and models to address these scenarios, extensive studies will likely need to be conducted that require a vast amount and diverse set of labeled data obtained under various network and radio conditions. Despite having an immense amount of data as a prerequisite to properly train QoE models, current solutions do not support massive data collection without human intervention. Furthermore, diversity is essential to build models that are able to generalize well either across different services or in a variety of network conditions. These requirements cannot be fulfilled by running manual tests, which are both time-consuming and expensive, as well as suitable only for covering a limited number of scenarios and parameter values that occur in real network environments. Accordingly, earlier approaches to model development based on deep expert knowledge are no longer feasible.

In contrast to these traditional methods of measuring service quality, leveraging the power of Machine Learning (ML) seems to be the most viable solution in the encryption era that can extract relevant patterns from raw traffic features and publicly accessible packet headers. ML algorithms can uncover hidden relationships and interdependencies between various network features.

To cope with high processing overhead and storage footprint, state-of-the-art analytics systems often apply advanced filtering algorithms and aggregate data at different levels. While service quality models may estimate per-session metrics, a detailed dataset is needed in the training phase. To this end, capturing experimental data with up to one second resolution in both radio and core networks may be necessary or advantageous to deeply understand traffic patterns in case of performance issues.

In LTE networks, QoS differentiation enables the mobile operator to prioritize subscriber's network traffic based on service-specific requirements. For instance, conversational voice and video streaming services will be treated differently due to the difference in their packet delay budgets and error rates. 5G brings enhancements to QoS handling, where Evolved Packet switched System (EPS) bearers are replaced by the so-called “QoS Flow” concept that allows policy enforcement at a more granular level. Additionally, 3GPP has defined QoS profiles (e.g., 5G QoS Identifier (5QI) classes) to support advanced URLLC services. Notwithstanding, in practice, there is a lack of available solutions to test and investigate these new capabilities.

In view of the above, an integrated data collection system and method are described herein for mobile networks. Particular embodiments of the system primarily aim to collect training data for ML models in order to predict the service quality of new delay critical service types transported over UDP/Real-time Transport Protocol (RTP), UDP/Secure RTP (SRTP) or UDP/QUIC protocols.

Embodiments of the system may be suitable for testing new radio bearers and settings used for these new service types in 5G mobile networks. Embodiments may additionally or alternatively be suitable for deriving relations between different radio issues and transport characteristics and end user service quality.

The system may be integrated into a wide variety of computing platforms (e.g., a laptop or other mobile device). In particular, the system may be integrated and mobile such that the system may be used to test real radio conditions and mobile conditions. For example, the system may be suitable for use in conducting drive tests. The system may additionally or alternatively include different transport monitors based on state-of-the-art Unix utilities, such as spindump, tcpdump, and/or monitors for recording high-resolution downlink and uplink radio environment measurements.

The output data of radio and transport monitors may be converted to the given resolution and format defined for the QoE ML models.

The end user service quality may also monitored and recorded. The system includes software-based and physical infrastructure manipulators that may be used for introducing transport (packet loss, delay, etc.) and radio environment (coverage, interference) degradations in a planned manner.

In some embodiments, the user designs and configures measurement flows and test periods within the measurement flows, in which different transport and radio degradations can be applied, and even combined.

The end user service quality may be labeled either online or offline. The labeled data may be used for training the QoE ML models. The more detailed output of transport and radio data may be used for deriving the relations between radio metrics, transport metrics and end user service quality. A detailed packet dump provided by the system may enable the investigation of individual flows at the protocol level, e.g., with Wireshark.

The integrated data collection system and method captures high resolution transport traces together with radio environment measurement data and with explicit end user service quality observation, with the possibility of introducing various radio and transport disturbances at the same time.

Although the system is suitable for monitoring voice and legacy MBB traffic types, the system particularly enables investigation of service quality of URLLC traffic types in mobile networks and collection of training data for service quality models of URLLC traffic types.

The data collection system may be used for collecting labeled data for buffer-less or short-buffer delay-critical service types, transported over UDP/RTP, UDP/SRTP or UDP/QUIC. Uplink and downlink radio and transport data are captured at the same time for the bidirectional sessions. The collected data includes: downlink radio environment measurements, Reference Signal Received Power (RSRP), Reference Signal Received Quality (RSRQ), used frequency, timing advance, handover, uplink radio measurements (e.g., transmit power) and transport level QoS parameters such as packet loss, jitter, Round Trip Time (RTT), and high-resolution transport measures (e.g., bitrate, throughput). The transport and radio data may be collected with high time resolution (e.g., 1 second or less).

E2e service quality info may be derived for the above traffic types. The corresponding data may be equivalent to the cross-domain data obtained by network probes and node events for all sessions in a mobile network analytics system.

It should be noted that this data equivalency is not trivial. For example, packet loss is obtained from transport traces in the data collection system but this is not available in packet probes due to the encryption. Therefore, embodiments replace traditional packet loss obtained by such measures with radio protocol layer packet loss, which is available for network analytics systems in radio events. The resolution of available data can also be different.

The labeled data collected by this system may be suitable for training service quality models, operating in large scale, network-wide analytics systems.

With the data collection framework, data collection and test scenarios are executed in a planned manner, focusing on potential transport and radio issues occurring in mobile networks. Therefore, they may be particularly suitable for training service quality models to detect typical network issues.

Particular embodiments may be flexible in a variety of respects. For example, embodiments may support testing and data collection of virtual bearers, real bearers, 5QI classes, QoS profiles, and so on, particularly with respect to those dedicated to URLLC service types.

Particular embodiments may additionally or alternatively be comprehensive in one or several respects. For example, by introducing typical radio and transport issues artificially, characterizing training data can be obtained for training comprehensive QoE ML models. High resolution transport data may be obtained that allows for in-depth investigation of transport patterns in relation to different radio and transport degradations. E2e transport metrics may be derived for the test sessions. High resolution transport data may be obtained together with high resolution radio environment and mobility data. Thus, the relationship between radio interference and transport errors can be explored in a wide variety of ways.

Although transport packet characteristics are an important indicators of QoE, signal quality and mobility events can also highly affect the user experience in mobile networks. Therefore, it is expected that more exact URLLC service quality models can be developed by using both transport and radio packet level characteristics, as well as uplink and downlink radio environment measurement as input to these models then using only transport network characteristics. Notably, by capturing encryption keys at the end user, the encrypted protocol fields are also available for investigation.

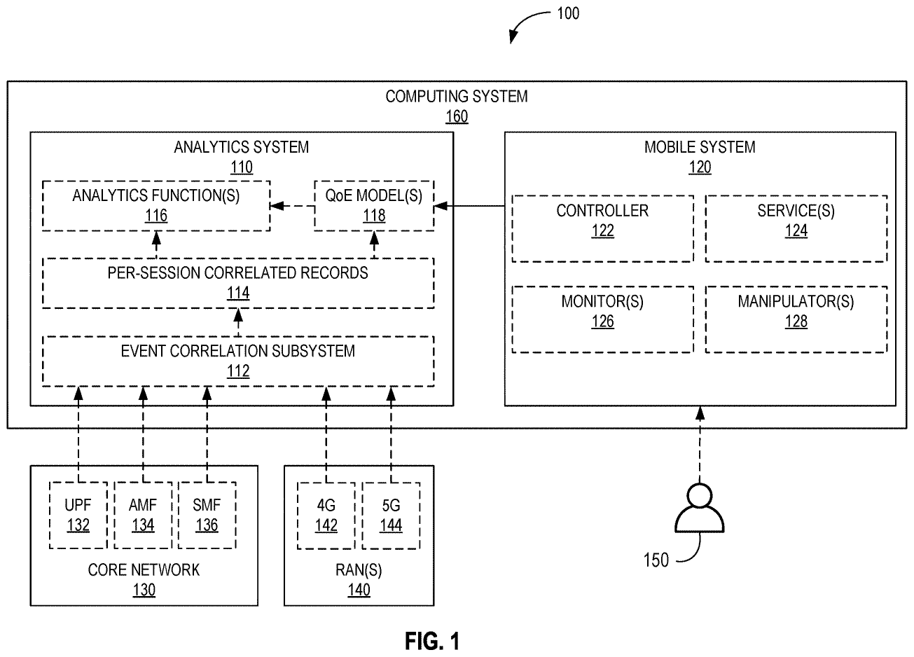

FIG. 1 is a block diagram that schematically illustrates the architecture of a wireless communication network 100 according to one or more embodiments of the present disclosure. Particular embodiments of the network 100 adhere to one or more 3GPP standards. The network 100 comprises a computing system 160, a core network 130, and one or more Radio Access Networks (RAN(s)) 140. The computing system 160 comprises an analytics system 110 and a mobile system 120, each of which comprises a respective set of one or more physical computing devices. For example, the analytics system 110 may comprise one or more server computers and the mobile system 120 may comprise a tablet, smartphone, and/or laptop computer. The RAN(s) 140 may comprise a 4G RAN 142 and/or a 5G RAN 144. As will be discussed in further detail below, the analytics system 110 and/or the mobile system 120 may additionally comprise one or more logical components (e.g., subsystems, records, models, functions, monitors, services, controllers, and so on).

In some embodiments, the core network 130 uses a service-based architecture in which architectural elements are defined in terms of network functions instead of network entities (e.g., as in a 5G Core (5GC)). Thus, the network functions may be implemented by any number of discrete computing devices (e.g., control network nodes). The network functions may be interconnected with the help of interfaces of a common framework to offer services to the users. For example, as illustrated in FIG. 1, the core network 130 may comprise an Access and Mobility management Function (AMF) 134, an Session Management Function (SMF) 136, and/or a User Plane Function (UPF) 132. In general, the UPF 132 may be responsible for handling user-plane data exchanged with a data network external to the core network 130 (e.g., the Internet, not shown). The UPF 132 may also support the handling of the user plane traffic based on the rules received from the SMF 136. The AMF 134 may be responsible for handling connection and mobility management tasks, e.g., for the mobile component(s) of the computing system 160 (to be discussed further below).

According to one or more particular embodiments, the analytics system 110 comprises an event correlation subsystem 112, per-session correlated records 114, one or more QoE models 118 and/or one or more analytics functions 116. During operation, the analytics system 110 may receive signaling events from one or more control functions of the core network (e.g. AMF 134 and/or SMF 136) and/or the UPF 132. The analytics system 110 may additionally or alternatively receive cell trace events from one or more radio base stations comprised in the RAN(s) 140. The event correlation subsystem 112 may be configured to generate per-session correlated records 114 from these received events. The per-session correlated records 114 may be used to generate and/or improve the QoE model(s) 118. The analytics function(s) 116 may use the QoE model(s) 118 and/or records 114, e.g., to predict and/or detect one or more network conditions.

The analytics system 110 further receives training data and/or labels for the QoE model(s) 118 from the mobile system 120. Because existing (and likely future) URLLC services are generally quite sensitive to disturbances, the mobile system 120 may be configured to collect a wide variety of data that potentially affects QoE. To the extent possible or practical, it would be advantageous for the data provided by the mobile system 120 to the analytics system 110 to be comprehensive and of high resolution, e.g., for use with the QoE model(s) 118. In this regard, the mobile system 120 may, in some embodiments, be configured with test scenarios and/or applications conducting one or more tests by a human user 150. The user 150 may additionally or alternatively label the data based on observations of end user experienced service quality for use in the QoE model(s) 118.

In this regard, the mobile system 120 may, in some embodiments, comprise a controller 122, one or more services 124, one or more monitors 126, and/or one or more manipulators 128, each of which will be discussed in greater detail below. In general, the controller 122 is configured to control startup and deployment of the service(s) 124 into the infrastructure of the network and to control startup and deployment of the monitor(s) 126. The monitor(s) 126 are configured to monitor the network and radio environment, and the manipulator(s) 128 are configured to manipulate characteristics of the network infrastructure.

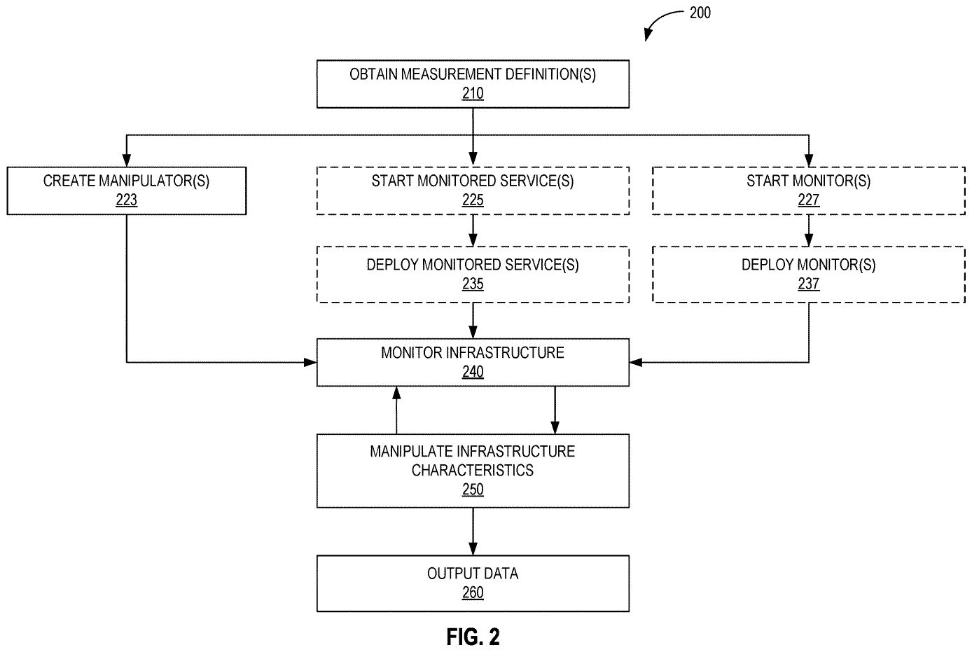

FIG. 2 is a flow diagram illustrating an example method 200 performed by the mobile system 120 according to one or more embodiments of the present disclosure. According to the method 200, data collection is performed to collect labeled data for buffer-less or short-buffer delay-critical service types transported over the network and the radio environment. A goal of the method 200 is to obtain radio and transport metrics (e.g., S-KPIs and R-KPIs) to gain adequate training data for service quality machine learning models and to predict QoE.

The method 200 begins by obtaining one or more measurement definitions (block 210). For example, to obtain metrics of an examined service, the user 150 may create a “measurement descriptor” with regard to a given service test. The measurement descriptor may, e.g., be a yaml file including a single or multiple periods during which infrastructure characteristics could change (e.g., different packet sending and receiving latency configurations in each period). To have a baseline to compare with results, the first period may be configured to use an original or default state. That is, the measurement to be performed may runs service(s) and any corresponding monitor(s) without any modification to an existing infrastructure characteristic.

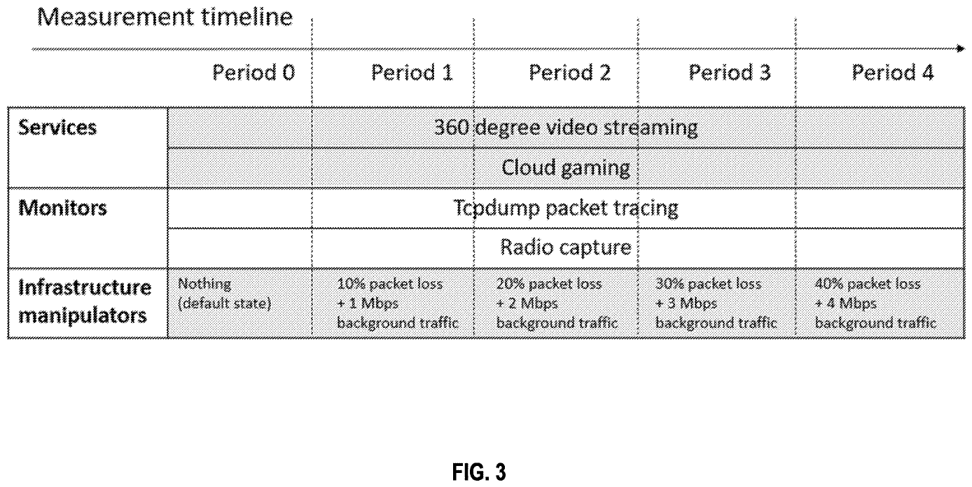

FIG. 3 schematically illustrates an example of a measurement descriptor according to one or more embodiments of the present disclosure. In the example of FIG. 3, the measurement descriptor describes two services (namely, 360 degree video streaming and cloud gaming) monitored by packet and radio capture tools that take place in each of five periods (i.e., periods 0-4). Period 0 represents a default state in which infrastructure is not manipulated. The following four periods are described as having continuously increasing packet loss and background traffic.

The number and the type of the services, monitor tools, and infrastructure manipulators may each be described by the measurement descriptor. In some embodiments, the measurement descriptor may be user-defined. In other embodiments, the measurement descriptor may be preconfigured.

The services and the monitors are indicated to run in each of the periods (e.g., continuously). In contrast, infrastructure manipulators are defined for only a simple period, the length of which may, in at least some embodiments, be configurable. Output data produced by the monitors may be saved in output package, e.g., in a given destination directory at the end of the measurement.

The controller 122 of the mobile system 120 may be configured to control the data collection and testing performed by the mobile system 120. In some embodiments, the controller 122 acts as an interface between the measurements performed by the mobile system 120 and the user 150 who would like to obtain the collected data. The user 150 defines the above-discussed measurement descriptor which specifies what service(s) 124 are to be examined with which monitor(s) 126 and with what infrastructure configuration(s).

Returning to FIG. 2, as the controller 122 processes the descriptor file, the controller 122 may be configured to start and/or deploy one or more services into the network infrastructure (block 225, 235), start and/or deploy one or more monitors (block 227, 237), and create one or more manipulators that influence infrastructure characteristics (block 223). The controller 122 may also configure the infrastructure in accordance with the measurement descriptor. The mobile system 120 monitors (block 240) and manipulates the infrastructure as specified by the measurement descriptor (block 250), saving measurement related data collected along the way for later processing, e.g., after all of the periods indicated in the measurement descriptor have ended (block 260).

One or more of the services 124 monitored by the mobile system 120 may be a URLLC application for which the mobile system 120 may be configured to predict QoE based on network and radio characteristics. Examples of such service(s) 124 include 360-degree video streaming, cloud gaming, immersive Augmented Reality (AR)/Virtual Reality (VR) applications, remote control, and industrial automation. Each of the services 124 may comprise start and stop methods by which they may be automatically controlled, e.g., by the controller 122.

As noted above, one or more of the monitors 126 may be configured to monitor the underlying infrastructure and its radio environment, e.g., by evaluating data produced by one or more deployed services 122. Each of the monitors 126 may be a tool used to collect data about the monitored environment. Such tools may include, e.g., tcpdump or spindump.

Collecting radio data, for example, may include the use of a custom application, as different devices may have different ways of extracting radio data. The collection of radio quality data allows the system to specifically measure low-latency services, as the quality of these services can be strongly affected by radio quality and mobility events unlike non-URLLC services, which can prevent such errors at the application level.

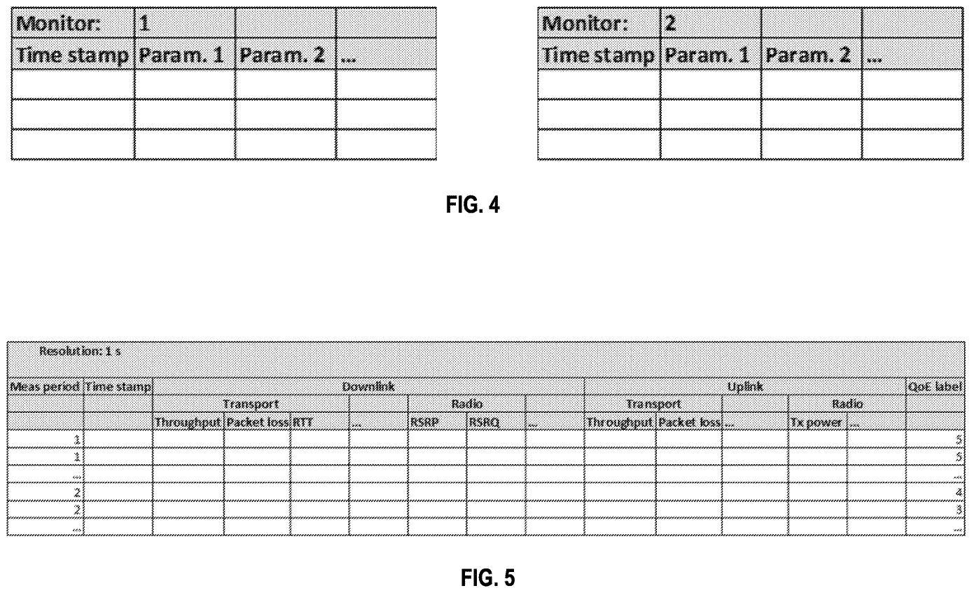

Similar to the services 124, each monitor may comprise start and stop methods by which they may be controlled during the measurement (e.g., by the controller 122). The data collected by each monitor 126 may be time-stamped and saved in a separate folder for late use in producing a single structured dataset. An example of a data output format per infrastructure monitor is shown in the tables of FIG. 4. As shown in FIG. 4, each monitor may produce a series of timestamped entries, each entry being associated with one or more parameters obtained by the monitor.

An example of a combined output of one or more selected parameters is illustrated in the table of FIG. 5. In the example of FIG. 5, the combined output structure of selected parameters having a common time stamp with a predefined time resolution is shown. The entries in the combined output may be labeled with end user service quality information, such as a QoE label.

The infrastructure monitors provide at least the same or equivalent data and metrics to those used ordinarily as input to the QoE models 118. That said, the infrastructure monitors may provide more detailed output for detailed investigations, e.g., deriving relationships between radio and transport metrics as well as for the different transport and radio degradations. These relations can be used for improving the accuracy of QoE models 118. Detailed packet capture (e.g., pcap) recordings may also be available for packet level analysis, e.g., using Wireshark.

The manipulators 128 are responsible for configuring infrastructure characteristics in each period of the measurement. For example, by using the linux command “tc,” packet loss, packet sending delays, and/or packet receiving delays can be set (among other things). The manipulators' 128 start methods are called at the beginning of each period to configure the infrastructure and the end methods reset the infrastructure settings at the end of each period.

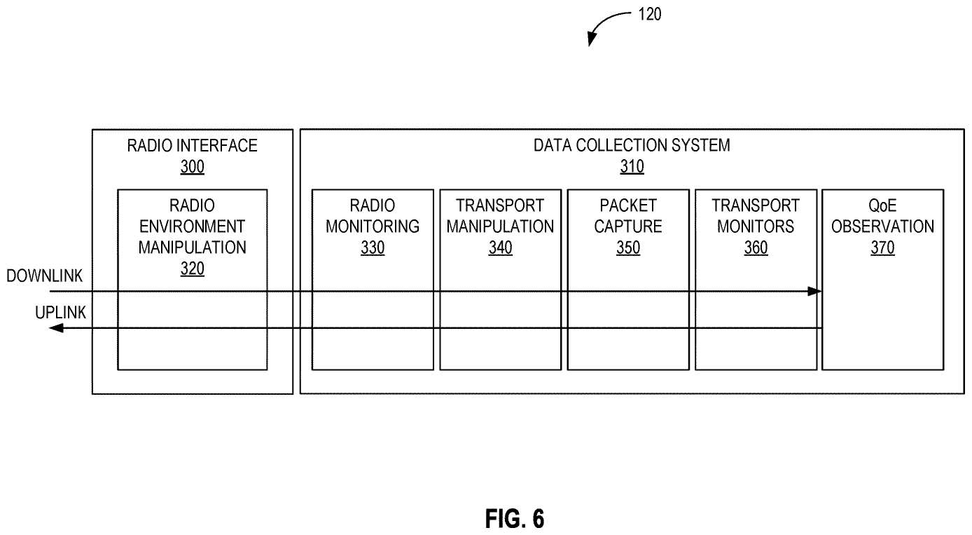

FIG. 6 illustrates an example of uplink and downlink data flows through example monitors 126 and manipulators 128 within components of the mobile system 120 according to one or more embodiments of the present disclosure. Radio environment manipulation 320 (e.g., shielding, interference) is done at the radio interface 300 outside of the data collection system 310. Uplink and downlink radio monitoring 330 is done at the radio interface within the data collection system 310. Transport manipulation 340 is performed (e.g., using the “tc” tool) between the radio interface 310 and packet capture 350. Transport monitors 360 (e.g., spindump) is performed between packet capture 350 and QoE observation 370. QoE observation 370 (i.e., where end user service quality is observed) is at the end of the data flow.

The monitors 126 and manipulators 128 are suitable for monitoring and manipulating both the downlink and the uplink data stream. However, the introduced degradations are monitored directly only in the downlink direction in this example of FIG. 6 because the degradations are introduced before the downlink data flow monitoring and after the uplink data flow monitoring.

The arrangement depicted in FIG. 6 renders it possible to emulate (e.g., using the “tc” tool) packet loss, jitter, and the like, in both the transport and radio interfaces. These can have different characteristics (e.g., statistics, burstiness) which can be set in the “tc” tool. It is also possible to add background traffic and/or bandwidth limitations (e.g., modeling a crowded cell and/or traffic shaping).

Although the uplink radio environment and transport degradation cannot be observed directly by this arrangement, it is nonetheless possible to monitor and observe the effect of uplink degradations indirectly on the downlink data flow (e.g. if acknowledgement (ACK) or other packets are lost).

The monitored infrastructure is responsible for running the services 124 started and/or deployed by mobile system 120. The system is designed such that any browser-based service can be started automatically for the measurements. Since the system is modular in design, testing a new service 124 merely requires writing the code snippets needed to start and stop that service and adding that code to the code base.

The emulation of cloud gaming, video conferencing, and/or live video services may be implemented and controlled using the Selenium framework. Selenium can be used to mimic a live user, e.g., by mimicking mouse movements and clicks in a predefined sequence and timing. Specific applications that have been experimentally emulated include NVIDIA Geforce Now, Jitsi Meet, YouTube Live.

The data generated when a service is used is saved and the quality of service experienced by the end-user is labelled offline (either manually or automatically). This may include, for example, saving all downloaded audiovisual data. Thus, according to one or more embodiments, it is possible to manually determine the quality of the service by watching the videos manually or automatically using different algorithms.

High resolution packet capture for URLLC examples service types may be performed using RTP and QUIC protocols. Currently, most applications and services that require real-time communication (e.g., video conferencing applications, cloud gaming) use the WebRTC framework. The essence of the WebRTC framework is that communicating parties communicate directly peer-to-peer using RTP protocol. In fact, DTLS-SRTP is used to encrypt the RTP payload, but not the RTP headers. The Synchronization Source (SSRC) can be read from the public header and used to identify the different audio and video streams. The timestamp and sequence number can be used to calculate packet loss, jitter and other QoS KPIs.

A protocol analyzer such as Wireshark (or its terminal version tshark) may be used to capture and collect packets that can be associated with WebRTC communication. In addition to the information that can be extracted from the packets, the system may also be prepared to retrieve and use WebRTC's internal logs and statistics. This information is normally used for debugging and development, but for embodiments of the present disclosure contains valuable data such as decoding speed of audio and video packets, packet retransmission requests, and other data that ordinarily cannot be seen because of encryption. For example, for WebRTC sessions launched from the Google Chrome browser, this information can be accessed from the “chrome://webrtc-internals/” page.

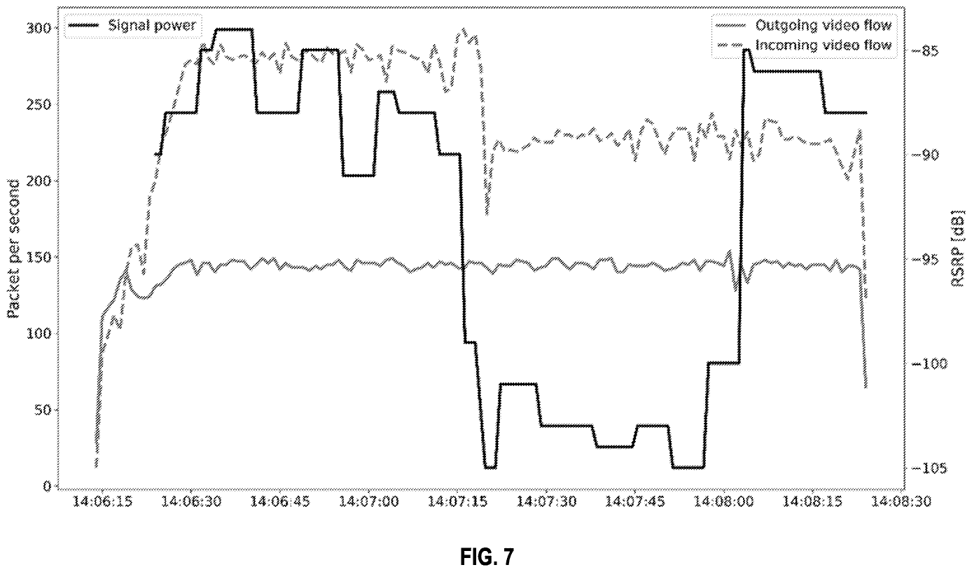

To analyze a measurement, the collected data is visualized. WebRTC data may be analyzed using the open-source real-time analyzer tool known as “Retina.” FIG. 7 shows example measurements of a Jitsi Meet video conference where the packets per second of 2 video streams are shown along with the corresponding signal power. As shown in FIG. 7, radio degradation (shielding) was applied around 14:07:15 that caused a sudden drop in the signal power followed by a drop in the incoming video packet transmission frequency.

QUIC is a relatively new transport protocol and there are an increasing number of packet capture tools that can be used to capture QUIC streams. Even though only a few applications and services currently use QUIC, there are a growing number of publications proposing the implementation of real-time communication over QUIC. Particular embodiments of the present disclosure collect and analyze QUIC packets.

The system includes infrastructure monitors capturing pcap files, which can be analyzed by a protocol analyzer capable of capturing QUIC packets transmitted over UDP (e.g., Wireshark). A large proportion of the data in a QUIC packet is encrypted and the fields that generally serve as a convenient foundation for analysis in TCP-based measurements are not available unless the encryption keys are known. Therefore, embodiments of the present disclosure evaluate the performance of the transport network without relying significantly on the encrypted part of the underlying protocol implementation. Indeed, QUIC leaves meager leeway for the network operators to observe the data flow and developers have traditionally had to rely on a few unencrypted fields to measure round trip times, throughput, bandwidth and to calculate metrics that can be fed into machine learning modules to predict user experience or QoS.

Such measurements require an in-depth knowledge on how QUIC works. There are well-tailored applications that can measure the aforementioned parameters. In order to do this, the system may use the Spindump tool, which is a very convenient tool to measure the peculiarities of the transport network. QUIC streams are usually composed of several individual connections, and these are identified by a parameter called connectionID. Spindump is able to perform measurements for each connection, detects spin transition and reports the RTT values.

The testbed implemented on the mobile system 120 may be built upon the Spindump codebase and may utilize the tool to measure round trip times in for each QUIC connection. As Spindump in debug mode typically generates a very lengthy output file, the data may be filtered to obtain particular data of relevance. In particular, the RTT values for every connection may be obtained. Spindump outputs these values as it receives a packet from the sender that has been detected before with an inverted spin bit value. In QUIC, the spin bit inverts once per end-to-end RTT. The system may collect these spin bit transition events and log them into the output folder so that these values can later be used to correlate with the rest of the collected data.

The mobile system 120 uses a 4G/LTE connection. In some embodiments, the 4G/LTE connection is provided by an external radio device connected through a Universal Serial Bus (USB) to support radio communication. The device may have an accessible Application Programming Interface that can be called to retrieve different radio parameters. These API calls may be performed periodically and automatically, e.g., with a Python script. The script can extract desired values from the Hypertext Transfer Protocol (HTTP) response such as RSRP, RSRQ, SINR, global cell identifier, eNodeB identifier, mode, uplink/downlink carrier frequency, modulation and coding, and/or uplink and downlink transmit power.

A timestamp is added to each record so that the data can be correlated with the captured packets that are also timestamped. This data collection mechanism can be customized in terms of the length of the measurement and data polling frequency (i.e., how often the LTE modem is polled for data).

Radio measurements are performed with different perturbation scenarios (i.e., during given perturbations). Different active and passive methods can be used, e.g., to block the radio signal partially and/or fully, thereby produce circumstances that can be repeated as needed.

For example, if we fully cover the LTE stick with a Faraday cage (if we can produce a 100% coverage), it is possible to block the incoming radio signals and make it inaccessible not only for 4G/LTE, but even for GSM. Partly open the Faraday cave or covering the stick with different foils were used for applying different level, reproduceable shielding.

To trigger a handover to another serving cell, the mobile system 120 may be physically moved. For this purpose, a vehicle may be used to move through specific places and to experience handover. There may be many regions where the 4G/LTE network is inaccessible or has poor quality due to lack of coverage. Measurements may be recorded under different conditions, e.g., in crowded urban areas and in poorly covered areas (e.g., valleys, uninhabited areas). This way, the way in which signal strength or transmitting power changes before/during a handover may be observed and the corresponding data correlated with the captured packets.

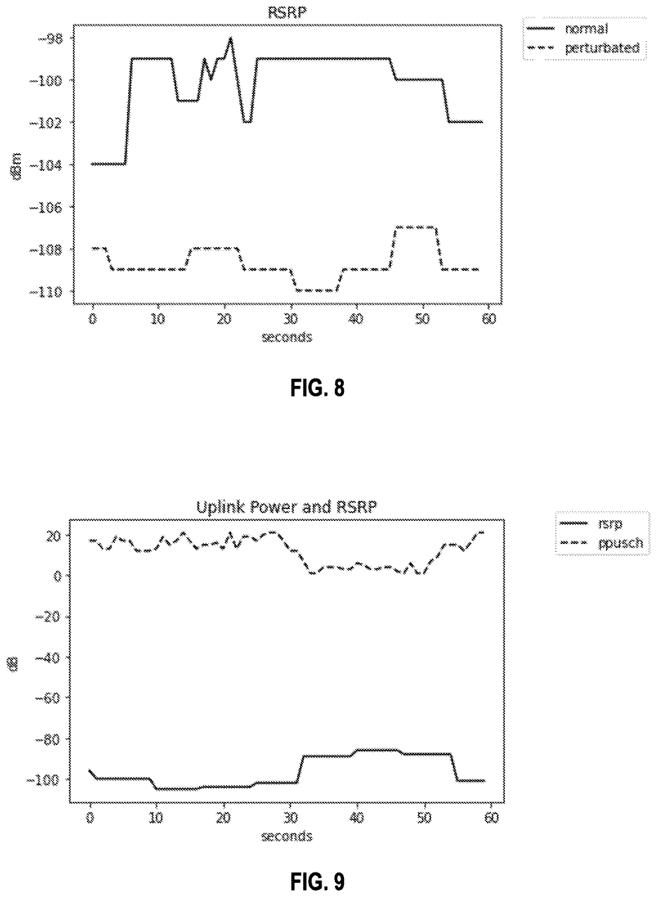

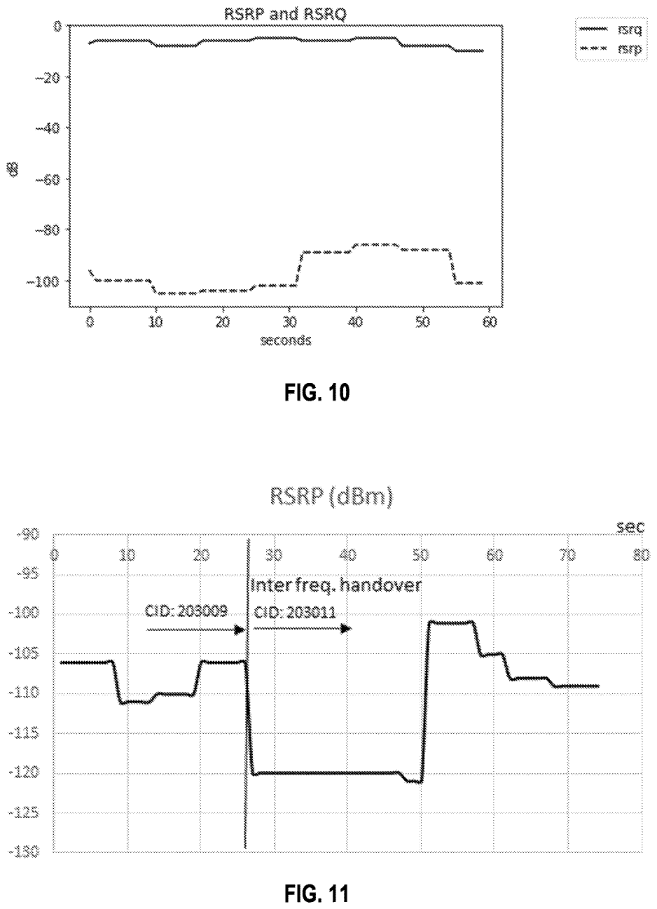

A few test measurements were experimentally created to test the output formats and the impact of a Faraday cage based radio perturbation. In FIG. 8, RSRP values of a normal measurement and a perturbated measurement can be seen for 60 seconds. In FIG. 9, the Power of the Physical Uplink Shared Channel (PPUSCH) is correlated with the RSRP values during a 60 second measurement. The Faraday cage is removed at the 30 second mark. In FIG. 10, an RSRQ/RSRP correlation is visualized.

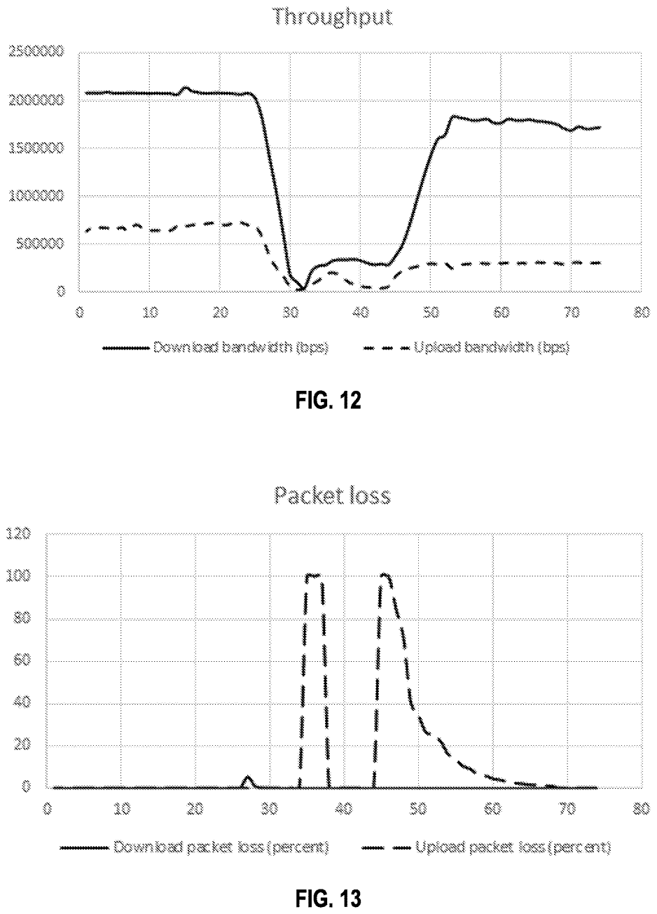

In another example test scenario, the radio receiver was shielded for about 20 seconds. As a consequence, an inter-frequency handover occurred and the signal strength dropped. FIGS. 11-13 show the observed transport degradations.

The mobile system 120 can be used, e.g., to test new radio bearers and QoS profiles dedicated to a new URLLC service type. As described before, mobile network operators may configure new 5QI classes and dedicated QoS profiles for new service types. Testing and investigating the operation and performance of such new profiles will be an important task in the service introduction phase. In this scenario, the mobile system 120 is used to run the new service and observe the end user service quality as a function of different radio and transport conditions while the radio and core network with the new profiles are considered as the system under test.

The mobile system 120 may be suitable for determining the boundary transport characteristics where QoS and QoE degradation can already be experienced in the examined service. The framework implemented by the mobile system 120 may enable standardized and reproducible measurements for various services and generates training data for the QoE ML models. Due to the measurement reproducibility, the border points in each characteristic (e.g., latency, packet loss, available bandwidth, etc.) may be determined, after which the QoS and QoE degradation can be experienced. Furthermore, the amount of training data for each service can be generated individually, making it possible to examine the service sensitivity for the network transport degradations separately. In some embodiments, multiple service-level QoE models may also be generated.

Different radio conditions (e.g., low coverage or high interference) may cause a significant decrease in the service quality at the end user. The mobile device 120 may correlate weak radio parameters with bad user experience (e.g., a jittered, delayed, or a completely unavailable service). A crowded urban area is expected to cause high interference and poor QoE for the user.

Another example in which a disturbed radio environment is used according to one or more embodiments is to trigger a handover which will eventually cause issues in the QoE. Travel by vehicle through several cells may enable the cell switching mechanism to be experienced. It is expected that both the radio signal and the service quality will be seriously impacted by the handover.

The data collected by the mobile system 120 may be used to train machine learning models that identify the relationship between network and radio conditions and QoE. These models can be used to predict the QoE experienced by the end-user from encrypted packets collected by the network operator in the middle of the network. The predicted QoE can then be used for various network management actions to more effectively achieve the promised QoE.

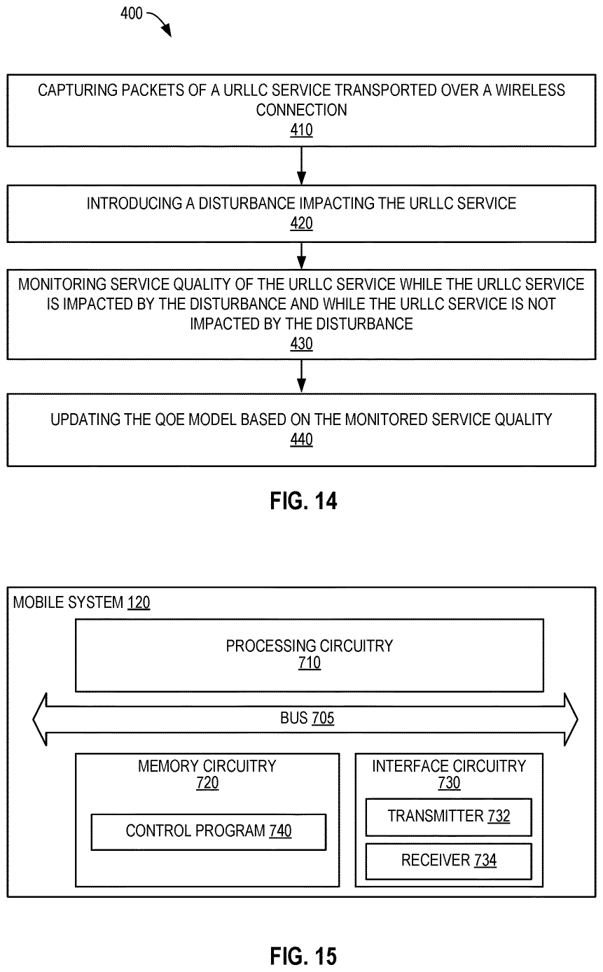

In view of all of the above, embodiments of the present disclosure include, e.g., the method 400 of training a QoE model 118, e.g., as illustrated in FIG. 14. The method 400 is implemented by a mobile system 120 and comprises capturing packets of a URLLC service transported over a wireless connection (block 410). The method 400 further comprises introducing a disturbance impacting the URLLC service (block 420). The method 400 further comprises monitoring service quality of the URLLC service while the URLLC service is impacted by the disturbance and while the URLLC service is not impacted by the disturbance (block 430). The method 400 further comprises updating the QoE model based on the monitored service quality (block 440).

Other embodiments of the present disclosure include a mobile system 120 implemented as schematically illustrated in the example of FIG. 15. The example mobile system 120 of FIG. 15 comprises processing circuitry 710, memory circuitry 720, and interface circuitry 730. The processing circuitry 710 is communicatively coupled to the memory circuitry 720 and the interface circuitry 730, e.g., via a bus 705. The processing circuitry 710 may comprise one or more microprocessors, microcontrollers, hardware circuits, discrete logic circuits, hardware registers, digital signal processors (DSPs), field-programmable gate arrays (FPGAs), application-specific integrated circuits (ASICs), or a combination thereof. For example, the processing circuitry 710 may be programmable hardware capable of executing software instructions stored, e.g., as a machine-readable computer program 740 in the memory circuitry 720. The memory circuitry 720 of the various embodiments may comprise any non-transitory machine-readable media known in the art or that may be developed, whether volatile or non-volatile, including but not limited to solid state media (e.g., SRAM, DRAM, DDRAM, ROM, PROM, EPROM, flash memory, solid state drive, etc.), removable storage devices (e.g., Secure Digital (SD) card, miniSD card, microSD card, memory stick, thumb-drive, USB flash drive, ROM cartridge, Universal Media Disc), fixed drive (e.g., magnetic hard disk drive), or the like, wholly or in any combination.

The interface circuitry 730 may be a controller hub configured to control the input and output (I/O) data paths of the mobile system 120. Such I/O data paths may include data paths for exchanging signals over a network. The interface circuitry 730 may be implemented as a unitary physical component, or as a plurality of physical components that are contiguously or separately arranged, any of which may be communicatively coupled to any other or may communicate with any other via the processing circuitry 710. For example, the interface circuitry 730 may comprise a transmitter 732 configured to send wireless communication signals and a receiver 734 configured to receive wireless communication signals.

According to particular embodiments, the interface circuitry 730 is configured to wirelessly exchange signals with a network. The processing circuitry 710 is configured to capture packets of a URLLC service transported over a wireless connection and disturb radio conditions impacting the URLLC service. The processing circuitry 710 is further configured to introduce a disturbance impacting the URLLC service. The processing circuitry 710 is further configured to monitor service quality of the URLLC service while the URLLC service is impacted by the disturbance and while the URLLC service is not impacted by the disturbance. The processing circuitry 710 is further configured to update the QoE model based on the monitored service quality.

Other embodiments include a computer program 740 comprising instructions that, when executed on processing circuitry 710 of a mobile system 120, cause the mobile system 120 to carry out the method 400.

Yet other embodiments include a carrier containing the computer program 740. The carrier is one of an electronic signal, optical signal, radio signal, or computer readable storage medium.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1-22. (canceled)

23. A method of training a Quality of Experience (QoE) model, implemented by a mobile system, the method comprising:
capturing packets of an Ultra-Reliable Low-Latency Communication (URLLC) service transported over a wireless connection;
introducing a disturbance impacting the URLLC service;
monitoring service quality of the URLLC service while the URLLC service is impacted by the disturbance and while the URLLC service is not impacted by the disturbance; and
updating the QoE model based on the monitored service quality.

24. The method of claim 23, further comprising correlating each of the captured packets with either when the URLLC service was impacted or when the URLLC service was not impacted by the disturbance, wherein updating the QoE model is further based on the correlated packets.

25. The method of claim 23, wherein:
monitoring the service quality of the URLLC service comprises collecting radio environment measurements of an uplink and/or downlink supporting the URLLC service; and
updating the QoE model based on the service quality comprises using the collected radio environment measurements as training data to train the QoE model.

26. The method of claim 25, wherein the radio environment measurements comprise signal quality measurements of the downlink and transmission power of the uplink.

27. The method of claim 23, wherein:
monitoring the service quality of the URLLC service comprises collecting radio configuration parameters of one or more radio devices supporting the URLLC service; and
updating the QoE model based on the service quality comprises using the collected radio configuration parameters as training data to train the QoE model.

28. The method of claim 27, wherein the radio configuration parameters comprise timing advance and/or a used frequency.

29. The method of claim 23, wherein:
monitoring the service quality of the URLLC service comprises collecting QoE configuration parameters associated with the URLLC service; and
updating the QoE model based on the service quality comprises using the collected QoE configuration parameters as training data to train the QoE model.

30. The method of claim 29, wherein the QoE configuration parameters comprise packet loss, jitter, and/or round trip time requirements for providing QoE with respect to the URLLC service.

31. The method of claim 23, wherein:
monitoring the service quality of the URLLC service comprises collecting transport measurements of the URLLC service; and
updating the QoE model based on the service quality comprises using the collected transport measurements as training data to train the QoE model.

32. The method of claim 31, wherein the transport measurements comprise bitrate and/or throughput measurements of the URLLC service.

33. The method of claim 23, wherein:
monitoring the service quality of the URLLC service comprises generating periodic sample data of the service quality, the periodic sample data having a resolution of not more than one second; and
updating the QoE model based on the service quality comprises using the periodic sample data as training data to train the QoE model.

34. The method of claim 23, wherein capturing packets of the URLLC service comprises capturing Real-time Transport Protocol (RTP), Secure RTP, and/or Quick UDP Internet Connections packets.

35. The method of claim 23, wherein:
the packets of the URLLC service comprise an encrypted portion and an unencrypted portion;
monitoring the service quality comprises deriving performance data of the URLLC service based on the unencrypted portion and without decrypting the encrypted portion; and
updating the QoE model based on the service quality comprises using the performance data as training data to train the QoE model.

36. The method of claim 23, wherein:
monitoring the service quality of the URLLC service comprises generating a round trip data sample for each of a plurality of spin bit inversions detected within the captured packets; and
updating the QoE model based on the service quality comprises using the round trip data samples as training data to train the QoS model.

37. The method of claim 23, further comprising performing a handover procedure responsive to the disturbance, wherein monitoring the service quality comprises monitoring the service quality before and after the handover procedure.

38. The method of claim 23, wherein introducing the disturbance comprises introducing a transport data disruption.

39. The method of claim 38, wherein introducing the transport data disruption comprises introducing packet loss, jitter, delay, packet reordering, congestion, and/or packet fragmentation.

40. The method of claim 23, wherein introducing the disturbance comprises introducing a disruption to radio conditions of the wireless connection.

41. A mobile system comprising:
processing circuitry and memory circuitry, the memory circuitry storing instructions executable by the processing circuitry whereby the mobile system is configured to:
capture packets of an Ultra-Reliable Low-Latency Communication (URLLC) service transported over a wireless connection;
introduce a disturbance impacting the URLLC service;
monitor service quality of the URLLC service while the URLLC service is impacted by the disturbance and while the URLLC service is not impacted by the disturbance; and
update a Quality of Experience (QoE) model based on the monitored service quality.

42. A non-transitory computer readable medium storing a computer program product for controlling a programmable mobile system, the computer program product comprising software instructions that, when run on the programmable mobile system, cause the programmable mobile system to:
capture packets of an Ultra-Reliable Low-Latency Communication (URLLC) service transported over a wireless connection;
introduce a disturbance impacting the URLLC service;
monitor service quality of the URLLC service while the URLLC service is impacted by the disturbance and while the URLLC service is not impacted by the disturbance; and
update a Quality of Experience (QoE) model based on the monitored service quality.
